(19) United States
(12) Patent Application Publication
(10) Pub. No.: US 2025/0210021 A1
(43) Pub. Date: Jun. 26, 2025

(54) A FOOT-OPERABLE PEDAL

(71) Applicant: Satish Chakravarthy Thaianban, Chennai (IN)

(72) Inventor: Satish Chakravarthy Thaianban, Chennai (IN)

(21) Appl. No.: 18/850,127

(22) PCT Filed: Mar. 15, 2023
(86) PCT No.: PCT/IN2023/050243

§ 371 Date: Sep. 24, 2024

Related U.S. Application Data
(60) Provisional application No. 63/365,242, filed on May 24, 2022.
(60) Provisional application No. 63/269,871, filed on Mar. 24, 2022.

(51) Int. Cl. G10H 1/34; G10H 1/00

(52) U.S. Cl. CPC G10H 1/348; G10H 1/0066; G10H 2220/271; G10H 2220/291; G10H 2240/311

(57) ABSTRACT

A disclosed pedal includes a base, a movable pedal element actuatable by a user's foot, a spring biasing the movable pedal element to a neutral position, a microcontroller, and a sensor unit, such as an integrated accelerometer/gyroscope dual sensor MEMS device carried by the movable pedal element, configured to send data to the microcontroller indicative of actuation of the movable pedal element, such as by sensing acceleration and angular velocity along three perpendicular axes. The microcontroller can generate an output signal as a function of user input to the movable pedal element and in at least two different modes, selected manually and/or automatically, including a switch mode and a continuous modulation mode. In switch mode the output signal is a discrete trigger, and in continuous modulation mode the output signal is continuously variable over a range.

### CROSS-REFERENCE TO RELATED APPLICATION(S)

The present application is based on and claims the benefit of: U.S. provisional patent application Ser. No. 63/269,871, filed Mar. 24, 2022; U.S. provisional patent application Ser. No. 63/363,783, filed Apr. 28, 2022; and U.S. provisional patent application Ser. No. 63/365,242, filed May 24, 2022.

### TECHNICAL FIELD

The present invention relates to user-operable pedals and associated methods of making and using the same. More particularly, the present invention relates to a foot-operable pedal suitable for use with a Digital Audio Workstation (DAW) environment.

### BACKGROUND

In music production, pedals associated with musical instruments are used to control parts of the instrument, or to provide extra notes. There are several musical instruments that have pedals for various reasons. A sustain pedal is a commonly used pedal by keyboardists universally, which provides a feature of sustaining notes played on keyboard or synthesizer or digital piano. Structurally, the sustain pedal is a simple contact switch either in the form of a piano pedal or a simple footswitch that is connected to a keyboard instrument (e.g., via a ¼″ phono cable). The sustain pedal closes the contact that is hardwired to the keyboards to provide sustain functionality electronically. Another popular keyboard pedal is a volume or expression pedal. The volume or expression pedal is a continuous controller and can also be connected to an input terminal of a keyboard to control volume or expression.

In the current era, a digital audio workstation (DAW) is based on a combination of electronic device and application software to provide utility for recording, editing and producing audio files. DAWs come in a wide variety of configurations ranging from a single software program on a computing device such as a laptop or a tablet, to an integrated stand-alone unit, all the way to a highly complex configuration of numerous components controlled by a central computer. Functionality of DAWs include audio recording, audio editing, musical instrument digital interface (MIDI) editing, mixing, and mastering, among others.

Further, various control interfaces or controllers on a full-sized MIDI control keyboard for a musician are used to control characteristics of musical sounds required to create music inside the DAW or on an electronic music production synth workstation or instrument, such as a pitch bend wheel, modulation wheel, faders, rotary encoders, touch sensitive strips, D-Beam™ controller, and the like. However, the existing controllers demand that one playing hand of the musician is occupied to control a parameter during performance, whether during creation of music or performance on stage. Hence, using these controllers hugely limits the extent of polyphonic performance a musician can perform with use of both hands on the keyboard.

Therefore, a logical solution to overcome limitations of the hand operated controllers is to execute their functionality using pedals. However, existing pedals have certain limitations. Wired pedal devices that are commonly used by keyboard musicians are unifunctional and have a large size comparable to that of a shoe and are not easily portable. For example, sustain pedal can only sustain notes without having to hold them down on the keyboard, while a volume or expression pedal can work only as a substitute to a modulation wheel in default mode. Both sustain and volume or expression pedals also need a dedicated ¼″ phono connector on a digital musical instrument or audio/midi interface to function.

Further, pedal plugins inside a DAW that are in current use by guitarists do have foot-actuated MIDI controllers, but these are in form factor of a pedal board to fully take advantage of their functionalities, need an external power supply and are not easily portable. These foot-actuated controllers definitely do not fall under the category of wireless portable MIDI controller. Existing drum pedals or trigger pedals are not available for general use outside hardware environment of an electronic drum kit or electronic drum sound module and hence cannot be used in a regular DAW or electronic music production setup.

Generally, DAW control surfaces are individual audio mixer-like units, which have to be separately carried and are not very useful during process of music creation, even though these surfaces can control multiple parameters in a DAW via MIDI. Therefore, these control surfaces again demand dedication of one hand to control of the parameters thereby limiting freedom of performing with both hands for a keyboardist or a guitarist.

Therefore, as the DAWs have taken over from the traditional keyboards, synthesizers or digital pianos as a primary music making instrument, there is an unaddressed need in the art for an evolved pedal providing enhanced functionality to modern day DAWs for music production that addresses the aforementioned deficiencies and inadequacies.

### SUMMARY

In one aspect, a pedal includes a base, a movable pedal element connected to the base and movable relative to the base, a spring arranged to bias the movable pedal element to a neutral position, a microcontroller including at least one processor, and a sensor unit operably connected to the microcontroller and configured to send data related to the movable pedal element to the microcontroller. The sensor unit can be an integrated accelerometer/gyroscope dual sensor micro electromechanical systems (MEMS) device carried by the movable pedal element. The microcontroller is programmed to generate an output signal during operation as a function of user force input to the movable pedal element. The output signal can be generated in at least two different modes including a switch mode and a continuous modulation mode. In the switch mode the output signal is a discrete trigger, and in the continuous modulation mode the output signal is continuously variable over a range.

Implementations of this aspect may include one or more of the following features. The sensor unit can be configured to sense acceleration and angular velocity of the movable pedal element along three perpendicular axes. A pivot connection can pivotally connect the movable pedal element to the base with only a single degree of freedom of pivoting movement. The pivot connection can be located at a middle portion of the movable pedal element, in between front and rear ends of the movable pedal element. The microcontroller can be further configured to utilize data from a proximity sensor to generate the output signal as a function of user input to the movable pedal element detected by the proximity sensor in the switch mode. The pedal and may further include a wireless transceiver operably connected to the microcontroller and capable of wirelessly sending and receiving signals. The wireless transceiver and an analog connector port can be configured to operate concurrently such that one is operable to transmit the output signal and the other is operable to independently transmit an additional output signal. The pedal and can further include a connector port operably connected to the microcontroller capable of creating a connection with an external cable. The microcontroller can be programmed to disable the continuous modulation mode as a function of feature version control instructions. The microcontroller can be programmed to automatically switch operating modes between the switch mode and the continuous modulation mode as a function of data from a user appendage-detecting sensor indicative of the presence or absence of a user appendage on the movable pedal element adjacent to the user appendage-detecting sensor. The user appendage-detecting sensor can be a force sensing resistor. The user appendage-detecting sensor can be located at a rear side of a pivot axis of the movable pedal element. An additional user appendage-detecting sensor can be located at a front side of the pivot axis. The microcontroller can be programmed to switch operating modes between the switch mode and the continuous modulation mode as a function of manual actuation of a button. The output signal can be in a musical instrument digital interface (MIDI) format. The pedal can be utilized as part of a system that further includes a host computing system running digital audio workstation environment software that is operatively connected to the pedal. The output signal can be converted to a musical instrument digital interface (MIDI) format by the host computing system.

In another aspect, a method of operating a pedal includes generating sensor data with a sensor unit as a function of actuation of a movable pedal element, sending the sensor data to a microcontroller, processing the sensor data with the microcontroller to determine a user actuation command, determining an operating mode of the pedal with the microcontroller, and generating an output signal as a function of the user actuation command, where the output signal is generated as a function of the operating mode then in effect. The pedal can be operable in at least a switch mode and a continuous modulation mode, where the output signal is a discrete trigger in the switch mode, and where the output signal is continuously variable over a range in the continuous modulation mode.

Implementations of this aspect may include one or more of the following features. The method can include generating a detection signal indicative of the presence of a user appendage on a rear portion of the movable pedal element, and using the microcontroller to automatically switch operating modes of the pedal between the switch mode and the continuous modulation mode as a function of the detection signal. The method can include using the microcontroller to switch operating modes of the pedal between the switch mode and the continuous modulation mode as a function of manual actuation of a button. The movable pedal element can be actuated by a user's foot. The method can include establishing a wireless connection between the microcontroller of the pedal and a first musical instrument, and wirelessly transmitting the output signal. The method can include providing a wired connection between the microcontroller and a second musical instrument via a connector port on the pedal, and transmitting signals along both the wireless connection and the wired connection concurrently and independently in the switch mode.

In another aspect, a method of operating a pedal includes generating sensor data indicative of the presence of a user appendage on a rear portion of a movable pedal element, where the movable pedal element is actuatable by the user appendage, sending the sensor data to a microcontroller, processing the sensor data with the microcontroller to automatically determine an operating mode of the pedal, and generating an output signal. The pedal can be operable in at least two different operating modes including a switch mode and a continuous modulation mode, where the output signal is generated as a function of the operating mode automatically determined by the microcontroller.

In yet another aspect, a pedal includes a base, a movable pedal element connected to the base and movable relative to the base, a microcontroller including at least one processor, a sensor unit operably connected to the microcontroller and the movable pedal element and further configured to send data to the microcontroller indicative of user actuation of the movable pedal element, and a wireless transceiver operably connected to the microcontroller and capable of wirelessly sending and receiving signals. The microcontroller can be programmed to generate an output signal during operation as a function of user input to the movable pedal element in at least a switch mode in which the output signal signals activation when the movable pedal element is depressed to a trigger point.

In yet another aspect, a foot-operable pedal is provided, which can optionally wirelessly communicate with a digital audio workstation (DAW) and/or one or more musical instruments, and which can further include multiple different operating modes such as a switch/sustain/drum mode and a modulation/expression mode, and which can optionally include automatic mode switching based on detection of user input such as the presence of a user's appendage (e.g., foot) on or near a given portion of the pedal. Other embodiments of this aspect include corresponding computer systems, apparatuses, and computer programs recorded on one or more computer storage devices in a non-transitory format, each configured to perform the actions of associated methods and/or provide configured operational functionality.

The present summary is provided only by way of example, and not limitation. Other aspects of the present invention will be appreciated in view of the entirety of the present disclosure, including the entire text, claims, and accompanying figures.

### BRIEF DESCRIPTION OF ACCOMPANYING DRAWINGS

The accompanying drawings are included to provide a further understanding of the present disclosure and are incorporated in and constitute a part of this specification. The drawings illustrate exemplary embodiments of the present disclosure and, together with the description, serve to explain the principles of the present disclosure.

In the figures, similar components and/or features may have the same reference label.

FIGS. 1A and 1B illustrate a perspective view and an exploded view, respectively, of a foot-operable pedal in accordance with an embodiment of the present invention.

FIGS. 1C, 1D and 1E illustrate a perspective view, an exploded view, and a side view, respectively, of a foot-operable pedal in accordance with another embodiment of the present invention.

FIG. 2A illustrates a side elevation view and FIGS. 2B-2D illustrate perspective view representations of a fold open mechanism of the pedal in various positions in accordance with an embodiment of the present invention.

FIGS. 3A-3F illustrate side view (FIGS. 3A-3C) and front view (FIGS. 3D-3F) representations of the pedal depicting its foot actuation operation in accordance with an embodiment of the present invention.

FIG. 4A-4C are exemplary block diagrams illustrating workflow of integration of pedal body and microcontroller with a Digital Audio Workstation (DAW) environment in accordance with an embodiment of the present invention.

FIGS. 5A-5B illustrate exemplary methods of implementing operational functions of the pedal in accordance with an embodiment of the present invention.

FIGS. 6A-6C illustrate exemplary representations of a DAW environment visual display in accordance with an embodiment of the present invention.

FIG. 7 is a schematic block diagram of an example embodiment of a musical performance system.

FIG. 8 is a top front perspective view of a pedal in accordance with another embodiment of the present invention.

FIG. 9 is an exploded front perspective view of the pedal of FIG. 8.

FIG. 10 is a flow chart of a method for algorithm-based witch mode operation.

FIG. 11 is a schematic representation of a sensor in accordance with another embodiment of the pedal, viewed from the top.

FIG. 12 is a schematic representation of a sensor in accordance with another embodiment of the pedal, viewed from the top.

FIG. 13 is a further schematic representation of a sensor in accordance with yet another embodiment of the pedal, viewed from the top.

While the above-identified figures set forth one or more embodiments of the present invention, other embodiments are also contemplated, as noted in the discussion. In all cases, this disclosure presents the invention by way of representation and not limitation. It should be understood that numerous other modifications and embodiments can be devised by those skilled in the art, which fall within the scope and spirit of the principles of the invention. The figures may not be drawn to scale, and applications and embodiments of the present invention may include features, steps and/or components not specifically shown in the drawings.

### DETAILED DESCRIPTION OF THE INVENTION

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

If the specification states a component or feature “can”, “could”, or “might” be included or have a characteristic, that particular component or feature is not required to be included or have the characteristic.

Example embodiments will now be described more fully hereinafter with reference to the accompanying drawings. This disclosure may, however, be embodied in many different forms and should not be construed as limited to the embodiments set forth herein, which are provided merely by way of example and not limitation. These embodiments are provided so that this disclosure will be thorough and complete and will fully convey the scope of the disclosure to those of ordinary skill in the art.

Any relative terms or terms of degree used herein, such as “substantially”, “essentially”, “generally”, “approximately” and the like, should be interpreted in accordance with and subject to any applicable definitions or limits expressly stated herein. In all instances, any relative terms or terms of degree used herein should be interpreted to broadly encompass any relevant disclosed embodiments as well as such ranges or variations as would be understood by a person of ordinary skill in the art in view of the entirety of the present disclosure, such as to encompass ordinary manufacturing tolerance variations, incidental alignment variations, transient alignment or shape variations induced by thermal, rotational or vibrational operational conditions, transitory signal fluctuations, and the like. Moreover, any relative terms or terms of degree used herein should be interpreted to encompass a range that expressly includes the designated quality, characteristic, parameter or value, without variation, as if no qualifying relative term or term of degree were utilized in the given disclosure or recitation.

In general, the present invention relates to a foot-operable pedal for use in a Digital Audio Workstation (DAW) environment. The pedal disclosed herein is a multi-functional foot operated controller device that provides full control over expressive and functional capabilities available to a creative or performing musician working in a musical instrument digital interface (MIDI)-enabled DAW environment. In one embodiment the pedal includes a pedal base, a movable pedal element (which can include separate from and back portions) that is movable relative to the pedal base, a wireless transceiver (e.g., Bluetooth® low energy transceiver), an accelerometer/gyroscope dual sensor, an infrared sensor, and a microcontroller. The signal data received by the microcontroller is used to detect motion of the movable pedal element based on user input (e.g., through actuation of the movable pedal element by a user's foot). The signal data from the sensors enables the microcontroller to implement functionality of a musical instrument controller, capable of using dynamic position of the pedal (with velocity sensitivity) to generate continuously variable command signals over a range or the infrared sensor to generate discrete command triggers. Output signals can be assigned to any desired MIDI channel(s) to control any number of musical parameters in the DAW environment. Other features and embodiments are disclosed herein, including in the accompanying drawings.

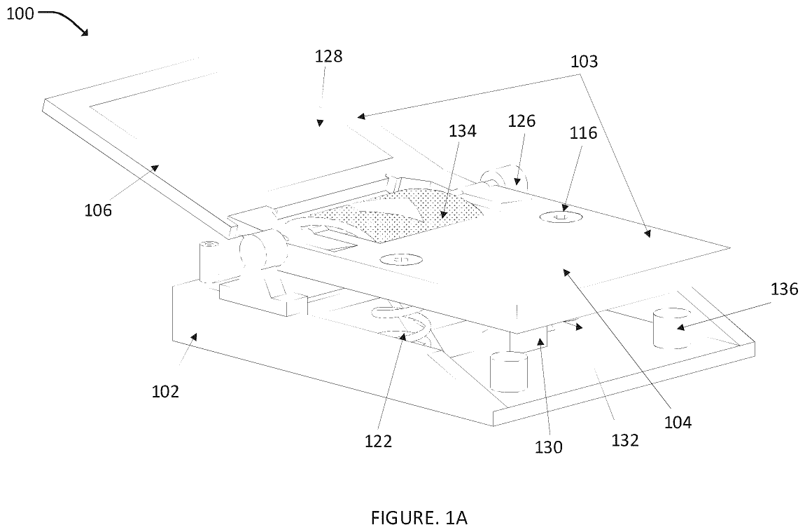

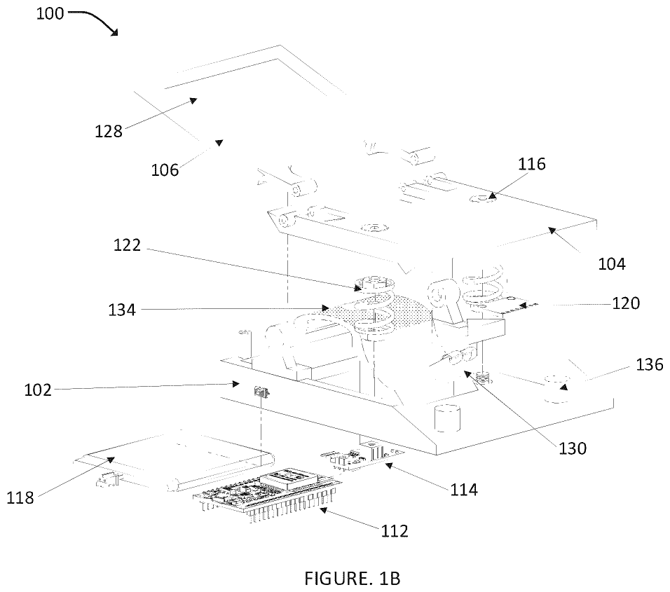

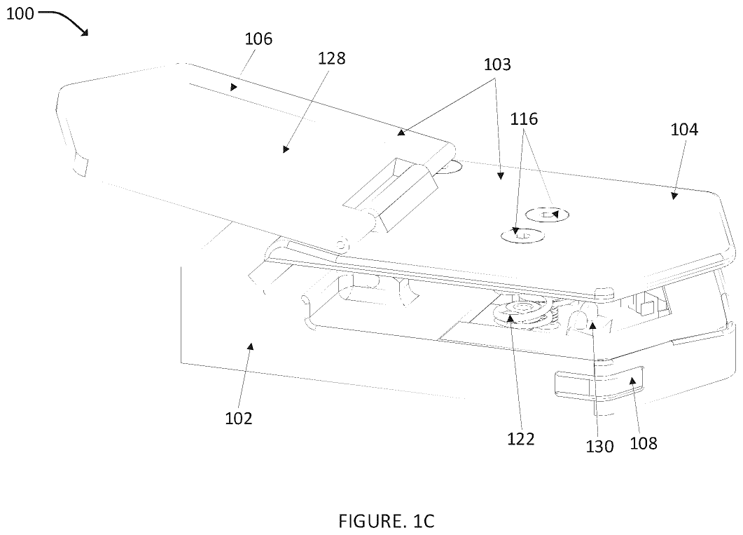

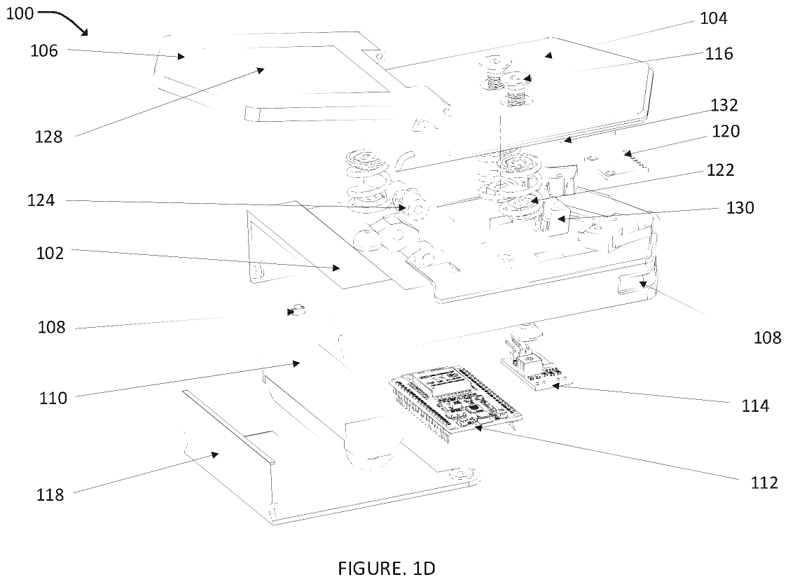

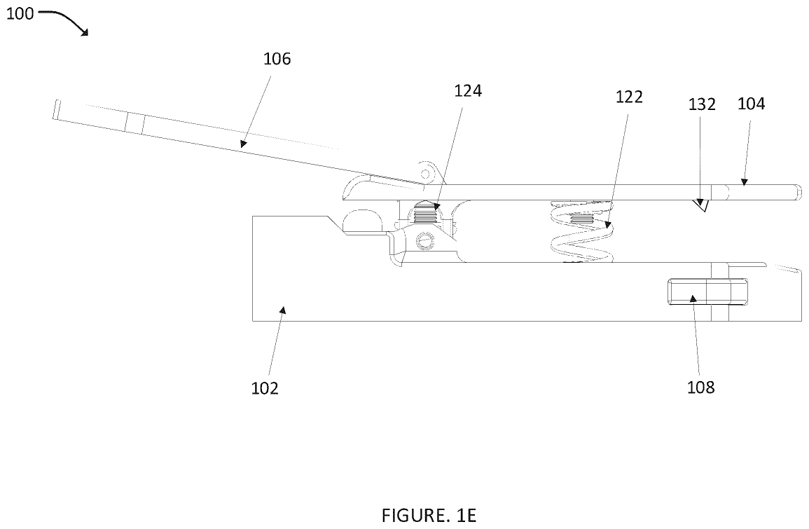

FIGS. 1A-1E illustrate perspective, exploded, and side views of a pedal 100 in accordance with an embodiment of the present invention.

The pedal 100 includes a base 102, a movable pedal element 103 (which can include a top front element 104 and a top back element 106 pivotally connected together in a flip-open configuration), a microcontroller 112 that can be a system on a chip (SoC) assembly that incorporates both a microprocessor and a wireless communications transceiver such as Bluetooth® low energy transceiver (e.g., an ESP32® SoC device available from Espressif Systems). Though in alternative embodiment separate processor and communications circuitry can be utilized. The microcontroller 112 can be operatively coupled with a sensor unit configured within an enclosure formed by top front element 104 and base 102 of the pedal 100. The sensor unit can be actuated by motion of foot of a musician or other user. The sensor unit can include but is not limited to any or a combination of a primary sensor unit 120, a secondary sensor unit 114, and/or a tertiary sensor unit 128 and/or 134.

In an example embodiment, the primary sensor unit 120 can be an accelerometer/gyroscope-based sensor (e.g., an accelerometer and a gyroscope inbuilt into a single Micro Electromechanical Systems (MEMS) device) mounted to the top front element 104, such as to a bottom surface thereof. In an embodiment, the primary sensor unit 120 can be used to generate signal data from sensed positional data in terms of velocities and/or angles.

The secondary sensor unit 114, in some embodiments, can be an infrared (IR) based proximity sensor mounted with the base 102, which can be used to detect position of the movable pedal element 103 (formed by the top front element 104 and a top back element 106) with reference to the base 102. When the pedal 100 is depressed or released, the secondary sensor unit 114 detects crossing of a threshold value in either direction, which enables the pedal 100 to act as an ON/OFF switch for triggering discrete musical events. In an embodiment, the tertiary sensor unit can include touch sensitive surfaces, e.g., touch sensitive surfaces of tertiary sensor unit(s) 128 and/or 134 mounted on top surface of the top front element 104 and the top back element 106 of the pedal 100, respectively. The tertiary sensor unit can also include at least one switch 108 that can be mounted on the base 102 or on either side of front portion of the pedal 100. While the touch sensitive sensor on the top surface can act as a gate for flow of continuous data generated by the primary sensor 120, the at least one switch 108 can act as dedicated switch(es) preset to certain functions of DAW control or mode control of the pedal 100.

In one example, the accelerometer/gyroscope-based sensor of the primary sensor unit 120 can be a sensor integrated circuit (e.g., a TDK InvenSense MPU-6050™ device), which is a MEMS sensor that can simultaneously detect both acceleration and angular velocity along three perpendicular X, Y&Z axes. When the sensor is mounted on an XY plane parallel to ground i.e., the XY plane is perpendicular to the Z axis or the direction of gravity, then output from the X and Y axis is purely angular along each individual axis. While the sensor output along the Z axis, being aligned with the direction of gravitational force of the Earth, providing a pure g-force readout in terms of meter per second squared.

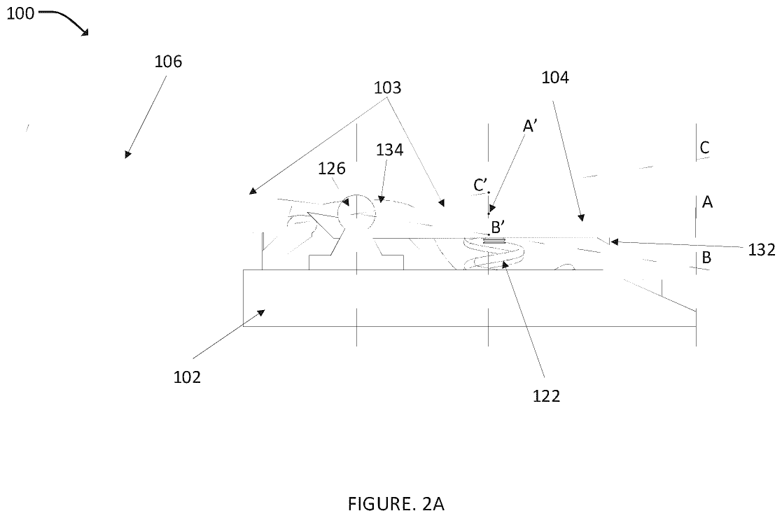

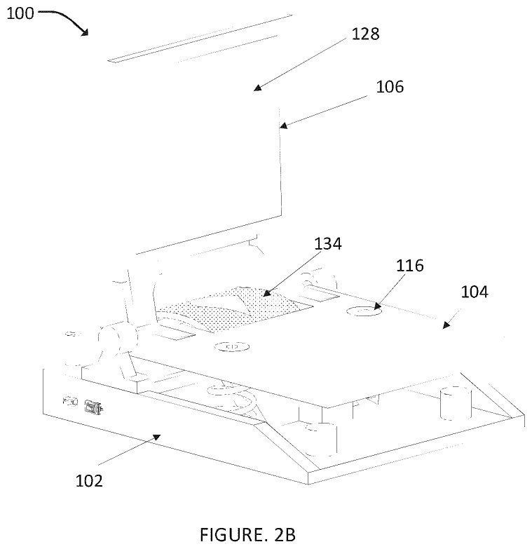

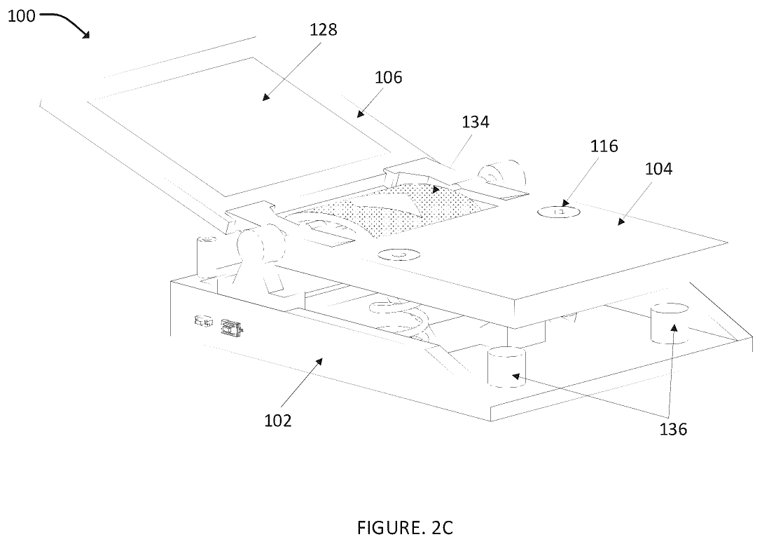

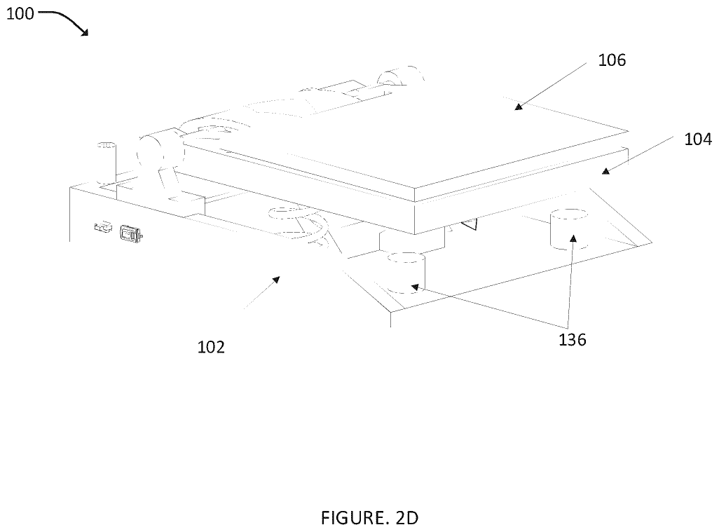

In one example, the proximity sensor 114 can be a sensor that emits an electromagnetic field or a beam of electromagnetic radiation (e.g. infrared radiation) from an emitter, and determines changes in field or return signal with a receiver. The object being sensed is often referred to as proximity sensor's target 132. The target 132 can be a white polygonal object mounted on fully black underside of the top front element 104. In one implementation, the proximity sensor 114 is configured with a fixture 130. The fixture 130 can hold an IR transmitter bulb and an IR receiver bulb that are part of the proximity sensor 114, such that IR wavers are transmitted toward the target 132 by the IR transmitted bulb and reflected IR waves are sensed by the IR receiver bulb. When the user applies pressure over the pedal element 103 through the foot, the target 132 travels from position C (refer to FIG. 2A) towards position B. Until position of the target 132 is just above position A, the proximity sensor 114 does not get triggered. When the target 132 broaches the position A, the signal voltage turns ON and stays ON as long as position of the target 132 is between position A and position B. The signal voltage turns OFF only when the target 132 is between position A and position C. Position A can be adjustably established using distance adjustment setting screw(s) 116 provided on the pedal 100. Therefore, the distance adjustment setting screw 116 manipulates sensitivity of the IR receiver so that at the position A, intensity of reflected IR radiation is enough to trigger the IR receiver of the proximity sensor 114.

In one example, the tertiary sensor unit can include touch sensitive sensors e.g., touch sensitive surfaces 128 and 134, and touch sensitive switches 108, such that upon the foot resting on the pedal 100 or coming into contact with touch surface area, capacitive switch terminals on the microcontroller 112 are turned ON. The touch surface can be made up of any or a combination of a conductive fabric, force sensitive resistors, and/or a flat electromechanical switch. The touch switches 108 on front left and right sides of the pedal 100 can be assigned multiple functionalities. Those skilled in the art would appreciate that most of the repeated functions for a user while creating music in a DAW environment is to trigger playback and trigger record feature. Therefore, in one implementation, a default functionality of the left front switch 108 can be set to trigger play/stop function of the DAW and the default functionality of the right front switch 108 can be used to trigger record function of the DAW. By making the play/stop and record functionality as part of the default setup of the pedal 100, there can be further reduction in workflow participation for hands of the user. Further, the switches 108 can be customized to trigger totally different functions based on the particular DAW environment that the user is working in.

Embodiments of the present invention provide musical functionalities that can be categorized into two broad categories: discrete and continuous. According to an embodiment, the discrete functionality is provided by the proximity sensor 114. For example, when upon actuating the pedal and the threshold distance of the IR sensor is broached by the target 132 there is an instantaneous stimulation of musical parameter being controlled (usually in the form of an ON signal via MIDI message) and continues to stay the same until release of the pedal sends an OFF signal. The intervening movement of the pedal past the threshold distance, between ON trigger and OFF trigger does not affect the status of the messages sent or the musical parameter thereto affected by the same and is only when the pedal returns to threshold does the status change.

According to another embodiment, the continuous functionality is provided by the accelerometer/gyroscope sensor 120. For example, upon actuating the pedal element 103 from the lowest position of the top front element 104 to the max position of the top back element 106 or vice-versa, a value commensurate to the instantaneous position of the pedal element 103 is transmitted to control the relevant musical parameter or event.

According to an embodiment, a battery 110 (e.g., a lithium polymer battery) can be configured between the base 102 and a base cover 118, to power electrical components of the pedal 100, as shown in FIG. 1D.

Those skilled in the art would appreciate that modes of functionality of the pedal 100 can be user assignable. The pedal 100 is a wireless (e.g., Bluetooth®) enabled device, enabling the device to cover multiple functionalities depending upon channel in which data is transmitted. In addition to the mode switch 108 built in to the pedal 100, a software dashboard on a computing device or an iOS/Android plugin running on a mobile device, can run the DAW, thereby allowing instantaneous access to various modes of the pedal 100 for quick access even in the middle of a performance.

Those skilled in the art would further appreciate that although exiting software versions of guitar plugins provide good sonic capabilities and existing hardware versions provide sound quality, there is no MIDI-compatible controller to take advantage of versatility of multifunctionality of the guitar plugins. Hence, the pedal 100 can provide guitarists a controller of familiar form factor and functionality that can be easily learnt for use any software plugin audio processors associated with a musical instrument.

Referring to FIGS. 2A-2D, the movable pedal element 103 can be formed by the top front element 104 and the top back element 106. The top back element 106 of the pedal 100 can be hinged (e.g. by using at least two screws 116 acting as hinge pins) to the top front element 104 of the pedal 100 to form a flip open mechanism. The point at which the two elements lock the pedal 100 can have an elevation of approximately 10 degree rise from horizontal base 102, resulting in the top back element 106 sitting at an angle of approximately 170 degrees when fully open from the top front pedal 104, in some embodiments. The foldable form of the movable pedal element 103 allows the pedal 100 to be opened up to a full foot size, capable of accommodating an adult foot full resting on the top element and yet small enough to be carried in a backpack in size of a single footswitch pedal while taking up just half the space when closed.

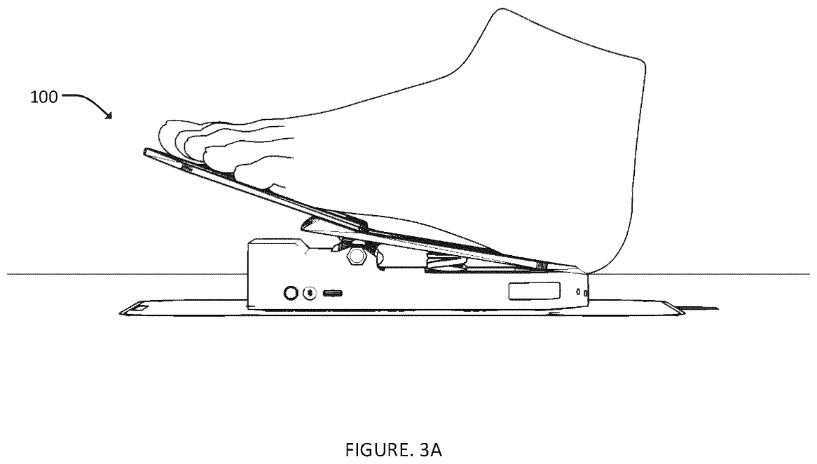

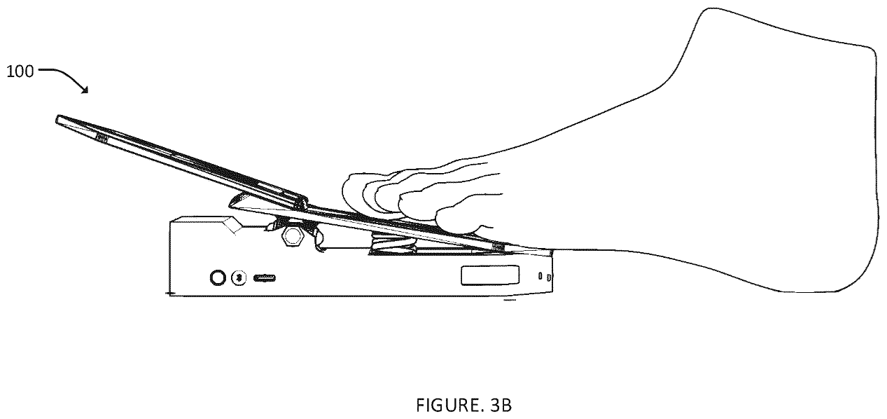

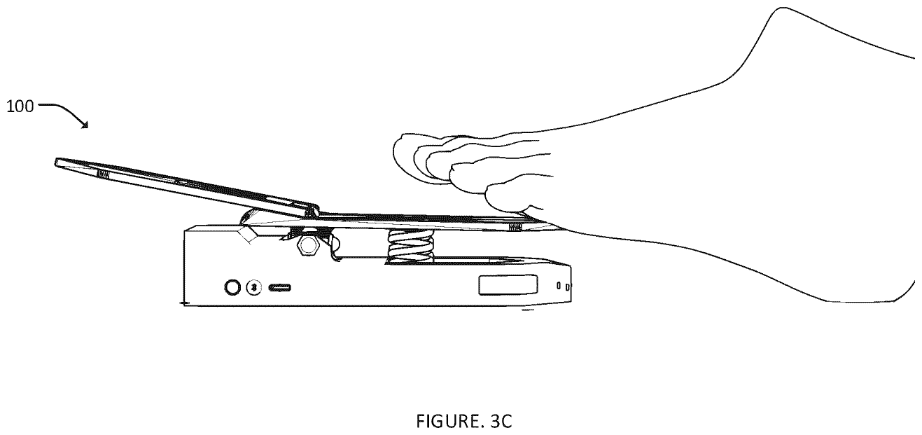

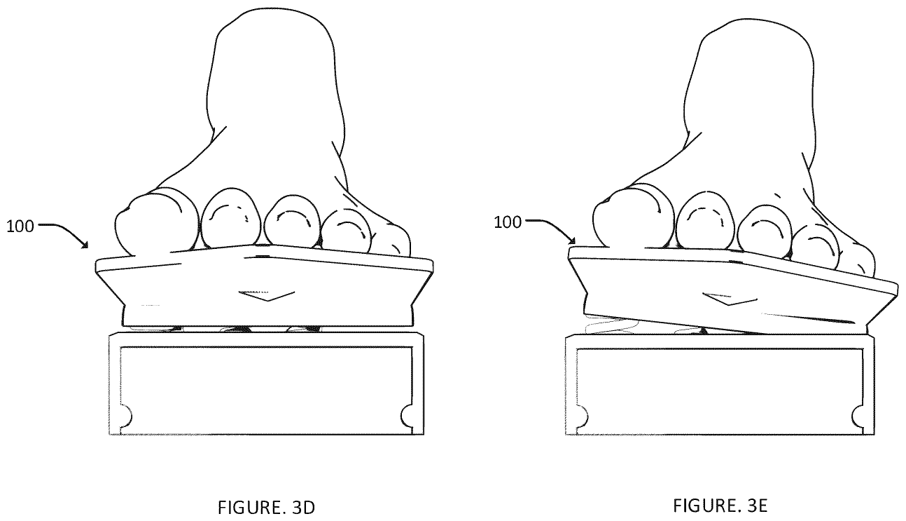

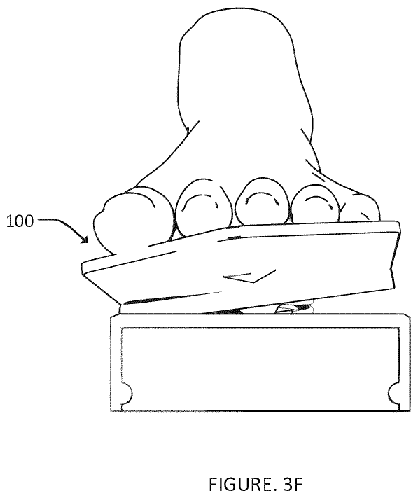

In one implementation, as illustrated in FIGS. 1A-1C, the flip- or fold-open mechanism can be achieved using a single degree of freedom hinge 126, which enables control of a single parameter at a time from the primary sensor. For example, FIGS. 3A, 3B and 3C illustrates seesaw or pivoting movement of the movable pedal element about one axis of rotation only.

In another implementation, as illustrated in FIGS. 1D-1E, the flip- or fold-open mechanism of the pedal element 103 can be achieved using a two degree of freedom gimbal 124, which enables simultaneous control of dual parameters from the primary sensor 120. Therefore, the fold-open mechanism with a gimbal 124 takes advantage of the capability of the primary sensor 120 to sense position and movement on both x and y axes. For example, FIGS. 3A, 3B and 3C illustrate seesaw movement of the top element in one direction and FIGS. 3D, 3E and 3F illustrates seesaw movement of the top element in a second direction. Software control on the host computing system 742 can determine whether the pedal needs to control a single MIDI parameter or dual MIDI parameters.

According to an embodiment, referring FIG. 2A in view of FIGS. 1A-1E, a spring mechanism can be configured between the base 102 and the top front element 104 of the pedal 100, which enables the flip open mechanism of the pedal 100 to provide both discrete and continuous functionality in the DAW environment. In a preferred embodiment, the spring mechanism can includes one or more double locking compression springs 122. In existing pedals, a coil compression is spring is locked (i.e., fixed) only at one end as the spring only needs to be compressed. However, according to an embodiment of the present invention, ends of the coil springs 122 can be locked (that is, fixed) to both the top front element 104 and the base 102 of the pedal element 103 to function in both tension and compression states, thereby making it unnecessary to have any springs underneath the top back element 106 of the pedal element 103.

In an implementation, referring to FIG. 2A, the spring 122 can each be mounted at about ⅓rd the cantilever length (e.g. XZ=90 mm, approximately) of the pedal base 102 (e.g. XY=35 mm, approximately) without compromising on life cycle of the springs 122. The total elongation and compression of the springs 122 when mounted at point Y for a total deflection of the pedal 100 can be:
in compression, e.g. AB=15 mm:

$${A}^{′} {B}^{′} = AB \times ( XY / XZ ) = 15 \times ( 35 / 90 ) = 5.83 mm$$

in tension, e.g. AC=15 mm:

$${A}^{′} {C}^{′} = AC \times ( XY / XZ ) = 15 \times ( 35 / 90 ) = 5.83 mm$$

Therefore, the total deflection is well within tolerance of the compression springs 122, as there are at least two springs sharing load on the pedal element 103. Further, stoppers 136 beneath the top front element 104 and the top back element 106 of the pedal 100 ensure that the springs 122 cannot be deflected beyond spring safety or durability limits.

Those skilled in the art would appreciate that embodiments of the present disclosure enable to have spring force for both the top back element 106 and the top front element 104 without having spring mounts beneath the top back element 106, thereby enabling foldable design of the pedal 100. The disclosed structure of the spring mechanism can result in a form factor of approximately 120 mm×100 mm×35 mm, for example, which is comparable to the smallest form factor for a sustain pedal available in the market today, approximately 100 mm×90 mm×25 mm. The spring mechanism enables a resultant savings in space occupied by the pedal 100, allowing the pedal 100 to be a device that can be easily carried in a laptop bag with most portable of music production setups and still have a functionality that covers devices that two to four times of volume in size.

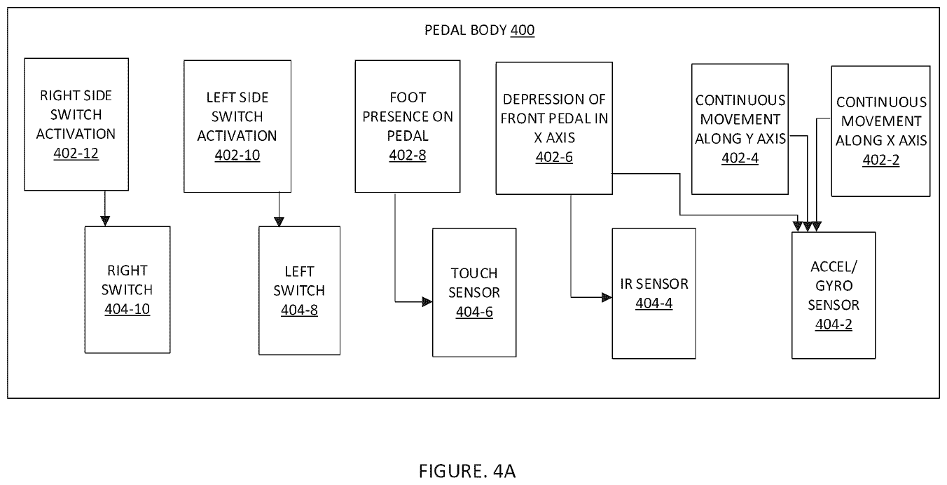

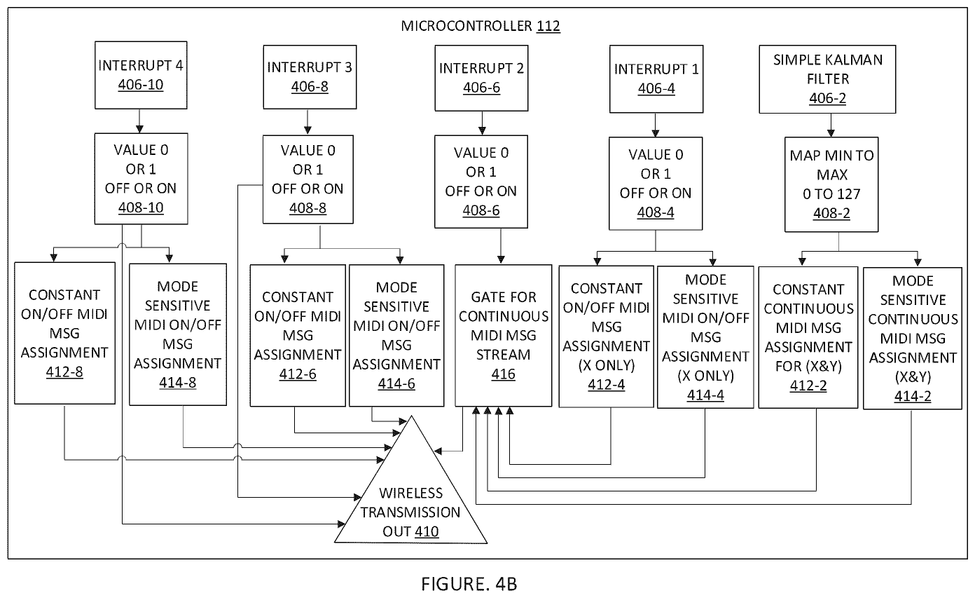

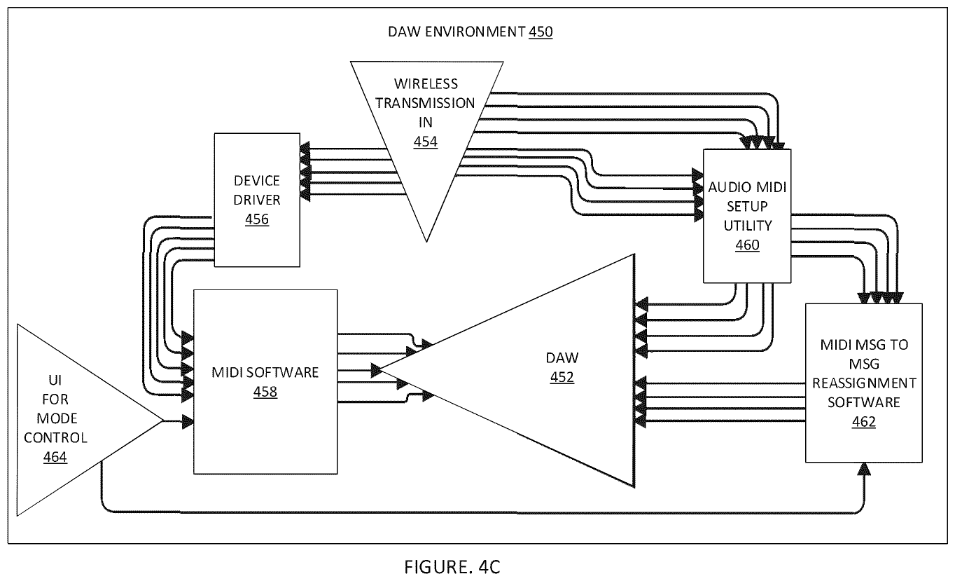

FIG. 4A-4C are example block diagrams illustrating workflow of integration of pedal body 400 and microcontroller 112 with a DAW environment 450 in accordance with an embodiment of the present invention. FIG. 4A is a block diagram representing the pedal body 400, FIG. 4B is a block diagram representing the microcontroller 112 and FIG. 4C is a block diagram representing the DAW environment 450.

According to an example, at the pedal body 400, blocks 402-2, 402-4 . . . 402-12 (which are collectively referred to as blocks 402 and individually referred to as block 402, hereinafter) represent of foot of a user with pedal body 400. For example, block 402-2 represents continuous movement of the pedal along X-axis, block 402-4 represents continuous movement of the pedal along Y-axis, block 402-6 represents depression of front portion of the pedal element 103 that can deflect along X-axis, block 402-8 represents presence of foot on the pedal, block 402-10 represents left side switch activation and block 402-12 represents right side switch activation.

According to an example, blocks 404-2, 404-4 . . . 404-10 (which are collectively referred to as blocks 404 and individually referred to as block 404, hereinafter) represent the sensors that get activated by the physical interaction. For example, block 404-2 represents that the accelerometer/gyroscope sensor 120 can be activated by continuous movement of the pedal along X-axis, continuous movement of the pedal along Y-axis or depression of front portion of the pedal that can deflect along X-axis. Further, block 404-4 represents that the IR sensor 114 can be activated by depression of front portion of the pedal element 103 that can deflect along X-axis, block 404-6 represents that the touch sensor 128 or 134 can be activated by presence of foot on the pedal 100, block 404-8 represents that the left switch 108 can be activated by activation of the left switch and block 404-10 represents that the right switch 108 can be activated by activation of the right switch.

According to an example, at the microcontroller 112, blocks 406-2, 406-4 . . . 406-10 (which are collectively referred to as blocks 406 and individually referred to as block 406, hereinafter) represent initial processing or interruption of a signal at the sensor in response to activation of the respective sensor of block 404. For example, block 406-2 represents that the input from the accelerometer/gyroscope sensor 120 passes through a Kalman filter, whereas blocks 406-4, 406-6, 406-8 and 406-10 represent discrete inputs from IR sensor 114, touch sensor 128 or 134, left switch 108 and right switch 108 generate interrupt signals.

According to an example, blocks 408-2, 408-4 . . . 408-10 (which are collectively referred to as blocks 408 and individually referred to as block 408, hereinafter) represent mapping of various values that can be generated in response to respective block 406. For example, block 408-2 represents that various values 0 to 127 in response to input from the Kalman filter due to activation of the accelerometer/gyroscope 120, whereas blocks 408-4, 408-6, 404-8 and 408-10 represent values 0 or 1 in response to input receive from the interrupts due to OFF or ON state of IR sensor 114, touch sensor 128 or 134, or left switch or right switch 108.

Referring to FIG. 4C in view of FIGS. 4A-4B, in one implementation, mapped data from blocks 408 can be directly transmitted in proprietary format (not MIDI messages) to a host computing system 742 incorporating DAW environment 450 via wireless transmission (e.g., Bluetooth® signal transmission) out 410 and in 454. The data can pass through device driver 456 into pedal software 458 controlled by a user interface for mode control 464. The software 458 can assign various MIDI messages based upon incoming mapped data from blocks 408. In other words, signals are transmitted from the pedal 100 to the external host computing system 742 that converts those signals to MIDI format using conversion software 458 for use in the DAW environment software 452. Software-based MIDI signal conversion, such as via a lookup table, will be understood by persons of ordinary skill in the art.

In an alternate implementation, blocks 412-2, 412-4, 412-6 and 412-8 (which are collectively referred to as blocks 412 and individually referred to as block 412, hereinafter) represent constant continuous MIDI message assignments. MIDI messages at blocks 412 are already fixed and can be constantly transferred to the host computing system 742 incorporating the DAW environment 450 using wireless-enabled MIDI capability i.e., wireless out 410 of the microcontroller 112. The host computing system 742 can receive the MIDI messages via the wireless in 454 into an audio MIDI setup utility 460. The MIDI messages can then pass to the DAW environment software 452 via a message to message reassignment software 462. The message to message reassignment software 462 can also be controlled via the user interface for mode control 464, where the message to message reassignment software 462 with user interface 464 can reassign the incoming MIDI messages to specific outgoing MIDI message formats. Those skilled in the art would appreciate that using the technique of reassignment, the user can assign multifunctional capability even though the incoming MIDI messages are constant and unchanging.

In yet another implementation, blocks 414-2, 414-4, 414-6 and 414-8 (which are collectively referred to as blocks 414 and individually referred to as block 414, hereinafter) represent mode sensitive MIDI messages assignments, where the user interface for mode control 464 associated with the host computing system 742 can control mode of operation inside the pedal 100. Mapped data from blocks 408 can be assigned to unique MIDI messages based on mode control from the user interface 464. The unique MIDI messages can be then transmitted using wireless transmission (out 410 and in 454) to the host computing system 742, where the messages are routed through the audio MIDI setup utility 460 directly into the DAW environment 452.

In one implementation, block 416 represents a Gate for continuous MIDI message stream control. The gate can be only activated by presence of the foot on the touch sensor 404-6 (e.g., via tertiary sensor unit(s) 128 and/or 134). On activation of the gate, the MIDI message stream is allowed to flow using wireless transmission (out 410 and in 454) to the host computing system 742, where the messages are routed through the audio MIDI setup utility 460 directly into the DAW environment 452.

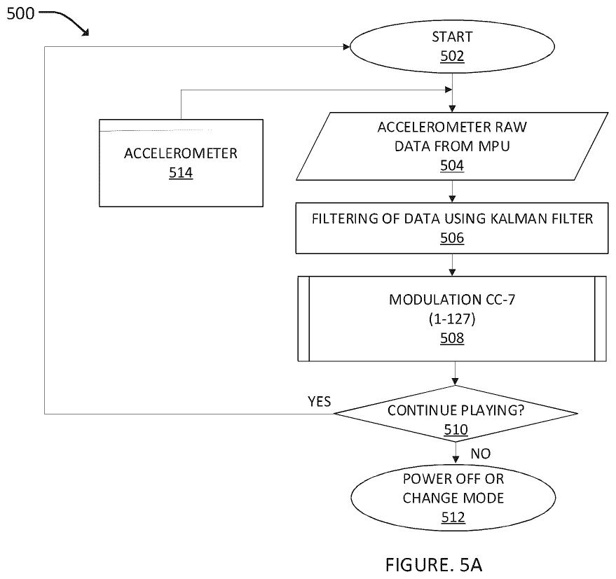

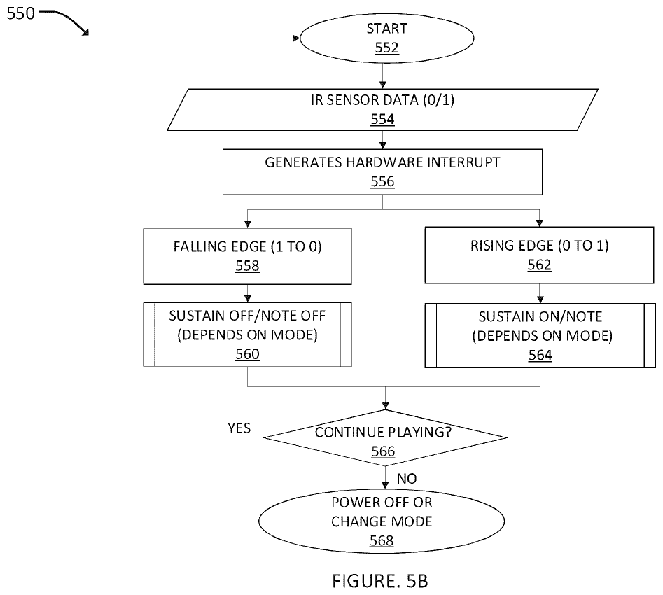

FIGS. 5A-B represent exemplary methods of implementing operational functions of the pedal 100 in accordance with embodiments of the present invention.

According to an exemplary method 500, as shown in FIG. 5A, the microcontroller 112 of the pedal 100 can function in modulation mode in response to receiving an input from an accelerometer 120. At block 502, the microcontroller 112 can initiate the process and at block 504, the microcontroller 112 can receive raw data from the accelerometer 120 (block 514). At block 506, the data can be filtered using a Kalman filter and at block 508, the filtered data can be mapped to MIDI modulation messages (CC-7 in MIDI Protocol). Further, at block 510 the microcontroller decides whether to stop playing or continue. In case of continue playing, the process again initiates at 502. Alternately, in case of stop playing, at block 512, the microcontroller either powers off or changes the mode of operation.

According to an exemplary method 550, as shown in FIG. 5B, the microcontroller 112 of the pedal 100 can function in sustain mode in response to receiving an input from an IR sensor 114. At block 552, the microcontroller 112 can initiate the process and at block 554, the microcontroller 112 can receive raw data from the IR sensor 114. At block 556, the microcontroller 112 can generate a hardware interrupt. At block 558, if a falling edge is detected, the microcontroller 112 can turn sustain “off” at block 560 (that is, deactivate sustain). Alternately, at block 562, if a raising edge is detected, the microcontroller 112 can turn sustain “on” at block 564 (that is, activate sustain). Further, at block 566 the microcontroller 112 decides whether to stop playing or continue. In case of continue playing, the process again initiates at 552. Alternately, in case of stop playing, at block 568, the microcontroller 112 either powers off or changes the mode of operation, based on user input via the mode control interface 464 and/or the switch(es) 108.

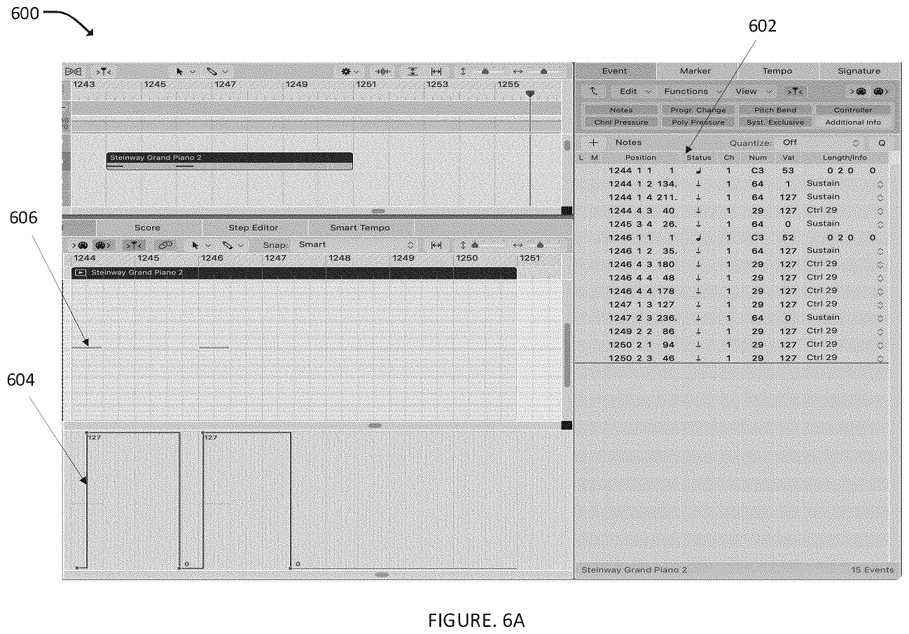

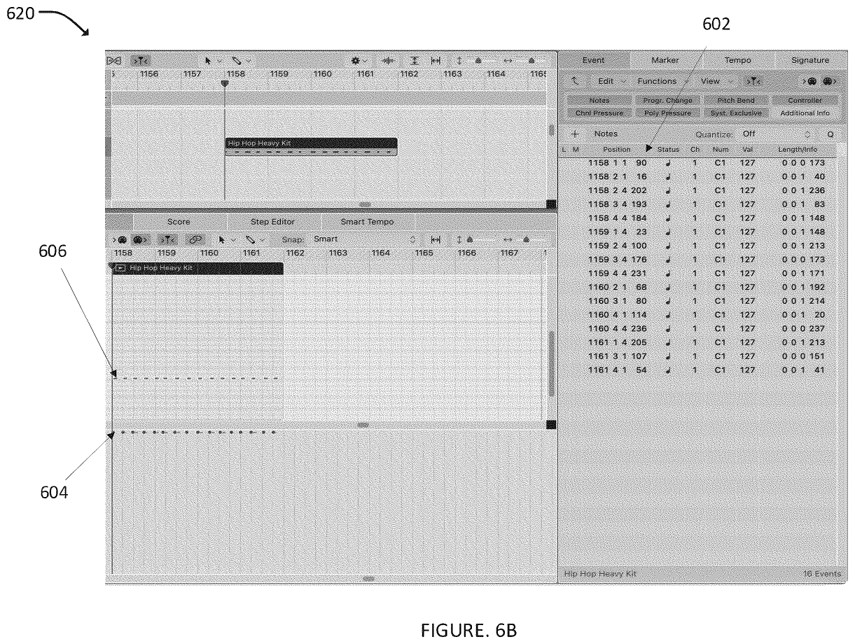

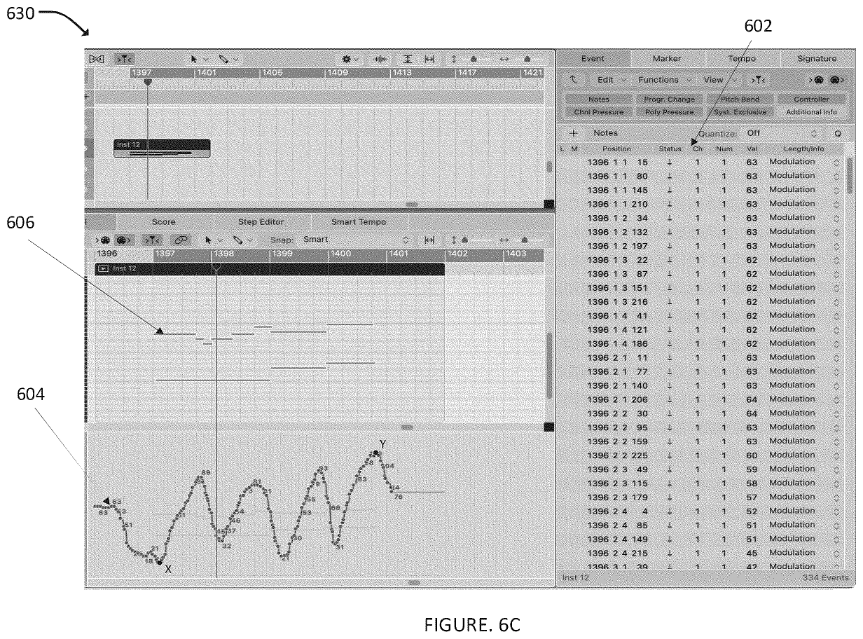

FIGS. 6A-6C illustrate exemplary representations 600, 620 and 630 of a DAW environment display in accordance with embodiments of the present invention.

As illustrated in representations 600, 620 and 630, an exemplary DAW environment can indicate a note 606 being played along with a velocity 604. The DAW environment display can also indicate an event list 602 along with numerical values of the events. Representation 600 indicates a DAW environment display when the pedal 100 operates in sustain mode i.e., either the note is ON or the note is OFF, which the pedal 100 can control using the secondary sensor 114. Representation 620 indicates a DAW environment when the note is triggered by stimulation of secondary sensor 114 and there is no velocity of the pedal element 103 detected by the primary sensor 120 and is preset at maximum value of val=127 as shown in display 602. Representation 630 indicates a DAW environment when the pedal 100 operates in modulation mode i.e., data from the primary sensor 120 can be used to correlate the angular position of the pedal 100 along the dorsal x-axis with a MIDI output (with a value 0 to 127 via a mapping algorithm) as recorded in the DAW environment. Accordingly, the sensed position of the pedal element 103 (as sensed by primary sensor 120) in modulation mode can achieve any value between minimum value X and maximum value Y based on position of the pedal element 103.

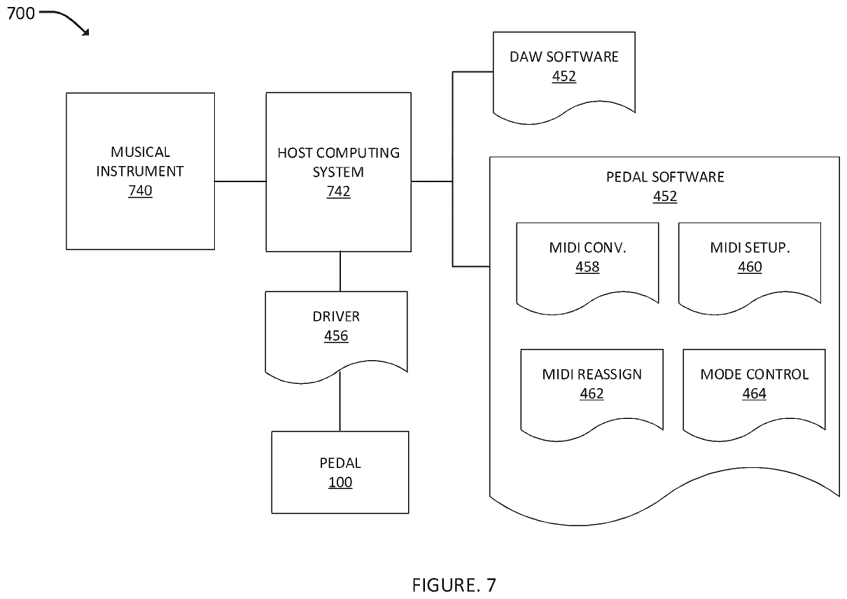

FIG. 7 is a schematic block diagram of an example embodiment of a musical performance system 700. The system 700 includes the pedal 100, a musical instrument 740, and a host computing system 742. The host computing system 742 can be a laptop computer, desktop computer, or the like, and generally includes at least one processor, suitable memory, at least one output device (e.g., a display or monitor, audio speaker, etc.), user input controls (e.g., a keyboard, mouse, touchscreen, etc.), and communications hardware (e.g., a wireless transceiver such as a Bluetooth® compatible low energy transceiver, wired connectors such as universal serial bus (USB) connectors, Internet-enabled networking device, etc.). Furthermore, the host computing system 452, and any of its processor(s), can be programmed with a device driver 456 for the pedal 100, the DAW environment software 452, and optional pedal software 757. The software can be stored in memory hardware on the host computing system 452. Though in alternative embodiments, the DAW environment software 452 and/or the pedal software 757 could be stored remotely (e.g., in cloud-based storage) and accessed by the host computing system 742 via the Internet, such as on a software-as-a-service (SaaS) basis.

The musical instrument 740 can be a digitally-enabled instrument, such as a digital keyboard device, or an analog instrument equipped with a digital output (e.g., a digital output pickup or microphone device). As shown in the illustrated embodiment, the musical instrument 740 is connected to the host computing system 742 to allow communication signals (e.g., audio signals) to be transmitted between them. The connection between the musical instrument 740 and the host computing system 742 can be a wireless or wired connection, in various embodiments.

The pedal driver 456 is installed on the host computing system 742. The pedal 100 is connected to the host computing system 742, and can interact with components of the host computing system 742 and devices and software connected to the host computing system 742, including the DAW environment software 452 and the optional pedal software 757. The connection between the pedal 100 and the host computing system 742 can be a wireless or wired connection, in various embodiments.

The pedal software 757 can be installed on the host computing system 742. In the illustrated embodiment, the pedal software 757 includes modules for non-MIDI to MIDI message (or signal) conversion 458, a MIDI setup utility module 460, a MIDI to MIDI message (or signal) reassignment module 462, and/or a mode control user interface module 464. The pedal software 757 can control operation and modes of the pedal 100, and can further control communications between the pedal 100 and the DAW environment software 452 and/or components of the host computing system 742 (e.g., its display, audio speakers, etc.).

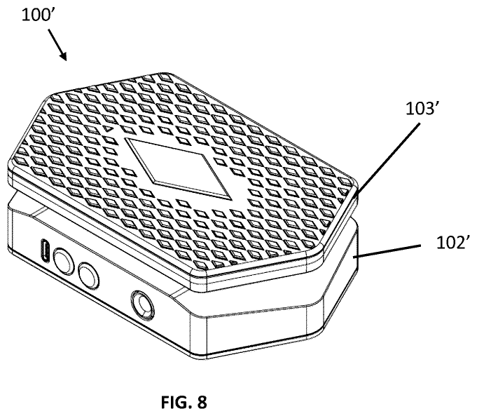

FIGS. 8-13 illustrate a pedal and related method of operation according to additional embodiments of the present invention, suitable for controlling signals associated with a musical instrument, such as in a digital audio workstation (DAW) environment, in a generally similar manner as with previously described embodiments. Signals can be received from a musical instrument to the pedal, and then a user can control the pedal with the user's foot (or other appendage) to control an output signal from the pedal, which can be sent to an external computer in musical instrument digital interface (MIDI) format or another desired format, for example.

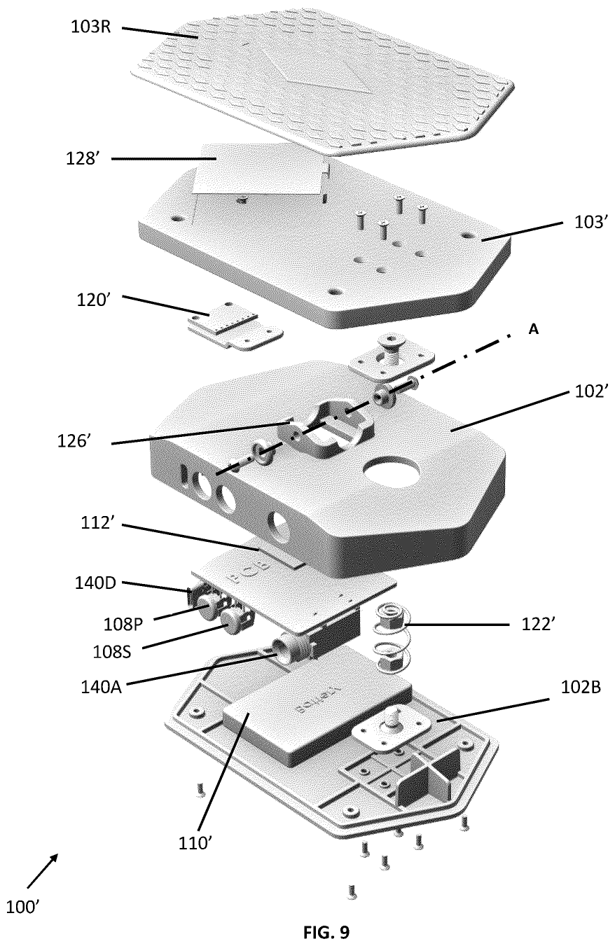

As shown in FIGS. 8 and 9, an embodiment of a pedal 100′ includes a base 102′, a movable pedal element 103′ (pivotally movable relative to the base 102′), at least one spring element 122′ operatively engaged between the base 102′ and the movable pedal element 103′, a power supply 110′ (e.g., a 1500-2000 mAh Li-Polymer rechargeable battery), a microcontroller 112′, and various sensors (e.g., sensors 120′ and 128′).

The base 102′ is a body that provides a foundation for the pedal 100′ that can rest on a ground surface. The base 102′ can have a removable bottom portion (or access panel) 102B.

In the illustrated embodiment, the movable pedal element 103′ is pivotally connected to the base 102′ by a pivot connection (or hinge) 126′ in a generally middle portion between front and rear ends. The pivot connection 126′ has a single degree of freedom in the illustrated embodiment, such that a user can pivot the movable pedal element 103′ in two directions about a pivot axis A (i.e., by depressing either a front end of the movable pedal element 103′ closest to the user or by depressing a rear end of the movable pedal element 103′ furthest from the user). The movable pedal element 103′ can optionally include a resilient material 103R at a top surface, which can optionally be textured, to help enhance user comfort and grip.

The one or more springs 122′ can be connected between the base 102′ and the movable pedal element 103′ (e.g., coil springs fixed at opposite ends to the base 102′ and the movable pedal element 103′, respectively) to bias the movable pedal element 103′ to an equilibrium or neutral position in the absence of user force input applied to the movable pedal element 103′, and in that way allowing the pedal 100′, when at rest, to be ready to accept user input to pivot the movable pedal element 103′ in either direction away from the equilibrium or neutral position. As shown in the illustrated embodiment, the spring(s) 122′ can be spaced from the pivot connection 126′.

The microcontroller 112′ can be a system on chip (SoC) processor (e.g., a ESP32® SoC device available from Espressif Systems) running a low energy wireless (e.g., Bluetooth®) MIDI library with multiple functions, or, in alternate embodiments, only two functions, for instance: a) Sustain/Switch/Drum and b) Modulation/Expression.

A sensor 120′ with accelerometer/gyroscope functionality can be carried by the movable pedal element 103′ (e.g., attached at an underside of the movable pedal element 103′, in between the movable pedal element 103′ and the base 102′) and used to sense the acceleration and rotational/angular velocity of the movable pedal element 103′ along three perpendicular X, Y & Z axes and send signal(s) to the microcontroller 112′ containing accelerometer/gyroscope-based sensor data in order to determine a position of the movable pedal element 103′ and/or control output signals from the pedal 100′. For example, the sensor 120′ can be an integrated circuit with accelerometer/gyroscope-based sensor functionality (e.g., a TDK InvenSense MPU-6050™ device) mounted on the movable pedal element 103′ (e.g., on the underside front end thereof) and operatively connected to the microcontroller 112′. The sensor 120′ can detect movement of the movable pedal element 103′ in terms of acceleration and/or velocity along multiple axes and send appropriate signal(s) to the microcontroller 112′ which can use that data to determine a position of the movable pedal element 103′ at any given time (e.g., an angular position relative to an equilibrium or neutral position). Additionally, in some embodiments, the sensor 120′ can generate signals usable to operate the pedal 100′ in either or both sustain/switch/drum or expression/modulation modes, without the need for a secondary proximity sensor.

Further, one or more user appendage-detecting sensors 128′ can be provided on or near a top surface of the movable pedal element 103′ to allow auto-switching between pedal operational modes, which can govern the manner in which the accelerometer/gyroscope-based sensor data is utilized by the microcontroller 112′ to control output signals from the pedal 100′. For example, the sensor(s) 128′ can be one or more force sensing resistors (FSRs) carried by the movable pedal element 103′ and provided on or near the top thereof, such as under the resilient material 103R. Operation of the sensor(s) 128′ is discussed further below.

One or more connector ports 140A and 140D can be provided on the pedal 100′. For example, a digital connector port 140D (e.g., a USB-C connector) can be provided for supplying external power and/or charging the battery 110′, for digital-to-analog conversion (DAC) (e.g., via an additional breakout cable—not shown) of an output signal, for firmware flashing, and/or other desired functions. Moreover, an analog connector port 140A can be provided for analog signal inputs and/or outputs, such as for accepting a conventional musical instrument cable wire analog plug. The analog connector port 140A and/or the digital connector port 140D, in combination with a wireless connection, can also allow for concurrent use with multiple musical instruments or other devices (e.g., in a switching/sustain/drum mode).

One or more buttons, switches and/or the like can be provided on the pedal 100′. For example, a power button 108P can be provided, which can have a built-in visual indicator (e.g., light-emitting diode), which can flash to indicate wireless connection status. A second button 108S (e.g., a mode switch button) can also be provided that can control the wireless connection and/or pedal operation mode switching, which can also have a built-in visual indicator (e.g., light-emitting diode). The visual indicators on the buttons 108P and 108S can together indicate various modes or status of the pedal 100′ during operation. In some embodiments, the visual indicators can each be a multi-color diode or array of different single-color LEDs. Long- and short-press operation of the buttons 108P and 108S can also enable additional control functions to be achieved using only a limited number of physical buttons. The following is an example of button functionality and associated visual indicator states: startup after power button 1080P is pressed—auto mode default (both LEDs stable ON); Single Press of second (mode) button 108S—dedicated/latched sustain/switch/drum mode ON (second button 108S LED Stable ON and power button 108P LED stable OFF); Second/Double Press of second (mode) button 108S—dedicated/latched expression/modulation mode (second button 108S LED Stable OFF and power button 108P LED stable ON); and Long Press of second (mode) button 108S—polarity change to wired sustain mode (both LEDs stable OFF). Other mode functions are possible including a particular button action for Wireless (e.g., Bluetooth®) Discoverable+Disconnect Mode (Flashing LED), and/or LED color indications such as Battery Low—red; Battery Half Empty—green; and Battery Full—blue.

The particular hardware described above is disclosed merely by way of example and not limitation.

The pedal 100′ can have multiple operation mode settings, including, for example, (1) Dedicated Switch/Sustain/Drum Mode (a latched mode for binary on/off switching control of output signals as discrete triggers), (2) Dedicated Expression/Modulation Mode (a latched mode for essentially continuously variable control of output signals over a range), and (3) Sustain+Expression Auto Switch Mode (described below). The dedicated sustain or expression modes can each provide different types of control over output signals from the pedal. The pedal operation modes can be user-selected via a manual switch or button, software-based controls (e.g., via an external computer), and/or be governed by automatic mode switching (e.g., as discussed below).

Expression/modulation mode can be provided using signals sent to the microcontroller 112′ from the sensor 120′ indicative of the instantaneous position of the movable pedal element 103′ over a movement range to provide continuous modulation of a parameter (e.g., a MIDI parameter) that can be reflected in an output signal from the pedal 100′. Such an expression/modulation mode can operate in the same or a substantially similar manner as described above with respect to other embodiments (see, for example, FIG. 5A and corresponding discussion).

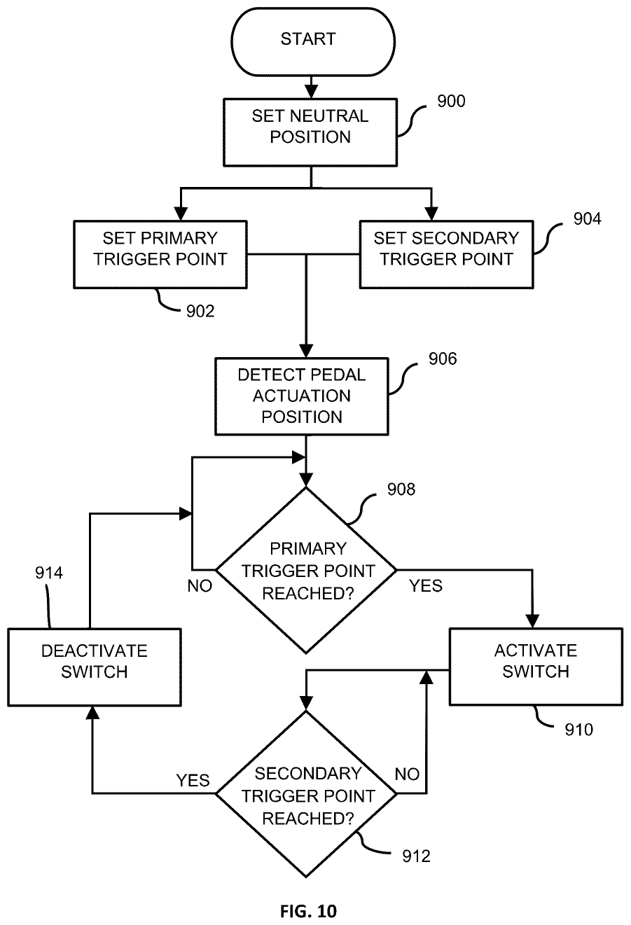

Switch/sustain/drum mode functionality of the pedal 100′ can be implemented using computer control and associated software utilizing signals from the sensor 120′. Switch/sustain/drum mode can be used to generate a binary on/off (or activated/deactivated) trigger output signal from the pedal 100′. For such sustain functionality, an algorithm-based software switch can use x-axis positional data derived from signals from the sensor 120′ (e.g., MPU-6050™ integrated circuit device mapped between 0 and 127). For example, when operating in sustain mode as shown in FIG. 10, if in an equilibrium or neutral position (e.g., without any user input force applied to the movable pedal element 103′), the positional data can be mapped to a desired value (e.g., 64) (step 900) and when the movable pedal element 103′ is depressed in front the x-axis positional data goes down to 0 at the lowest point. The pedal 100′ can set an arbitrary value of x-axis positional data (e.g., 45 or 46) as the primary trigger point for the sustain function when the numbers of the x-axis positional data are descending (step 902). A higher secondary turnaround trigger point can be set (e.g., 60 or 61 x-axis positional data) (step 904), which is used to re-arm the algorithm to look for the primary trigger point condition to be satisfied. Such re-arming can essentially provide a dead zone that avoids a false switch command caused by small movements of the movable pedal element 103′ while still depressed forwardly by a user, by allowing a new switch command to be recognized only after the movable pedal element 103′ returns to the equilibrium or neutral position or relatively close to it (e.g., within approximately the first 5-10% of the frontward depressible range of the movable pedal element 103′). The pedal 100′, using the microcontroller 112′ and signal data from the sensor 120′, can then detect and monitor the position of the movable pedal element 103′ and its direction of movement (step 906), which can happen on an ongoing basis. The microcontroller 112′ evaluates that position data (and optionally also direction of movement data) to determine if the primary trigger point is reached (step 908), when positional data are descending due to a user depressing the front of the movable pedal element 103′. When the primary trigger point is reached, the microcontroller 112′ can activate a switch/sustain/drum function (step 910). The microcontroller 112′ can continue to detect and/or monitor the position of the movable pedal element 103′ to determine if the secondary trigger point is reached (step 912), and, when the secondary turnaround trigger point is reached, the microcontroller 112′ can deactivate the switch/sustain function (step 914). In a drum mode, deactivation might instead occur effectively automatically following activation, such as after a drum sound is triggered, but the possibility of another activation at the primary trigger point can be re-armed following the secondary trigger point being reached, which can prevent unwanted drum sounds from being triggered, for instance. After the switch/sustain function is deactivated, the method is re-armed and can then return to detecting the pedal position and determining if the primary trigger point is reached (steps 906 and 908). When in sustain mode, movement of the movable pedal element 103′ in the rearward direction beyond the equilibrium or neutral position (e.g., mapped points 65-127) can have essentially no effect on the pedal's output signals or can otherwise be ignored in some embodiments. Such a sustain mode algorithmic switch avoids the need for any physical switch (e.g., avoids the need for a proximity sensor in addition to the sensor 120′ as described with respect to other embodiments), although a redundant physical switch can also be provided if desired. The algorithm-based software switch can be active only when the pedal operation mode is set (manually or via auto switching) to the sustain mode. Thus, the method illustrated in FIG. 10 can run continuously when the pedal 100′ is in the sustain mode and can terminate whenever sustain mode is discontinued.

Some embodiments of the pedal 100′ can include auto-mode-switch functionality, which can be implemented using the sensor(s) 128′ (e.g., FSR sensors). In that way, the pedal 100′ can transition between operating modes manually using a button or the like (e.g., the secondary button 108S) or via a command sent via the host computing system 742 (including the DAW environment software 452) operatively connected to the pedal 100′ (e.g., via a wireless connection) and/or via sensor-based auto-mode-switching. Example embodiments of the sensor-based, computer-controlled auto-mode-switching functionality are as follows.

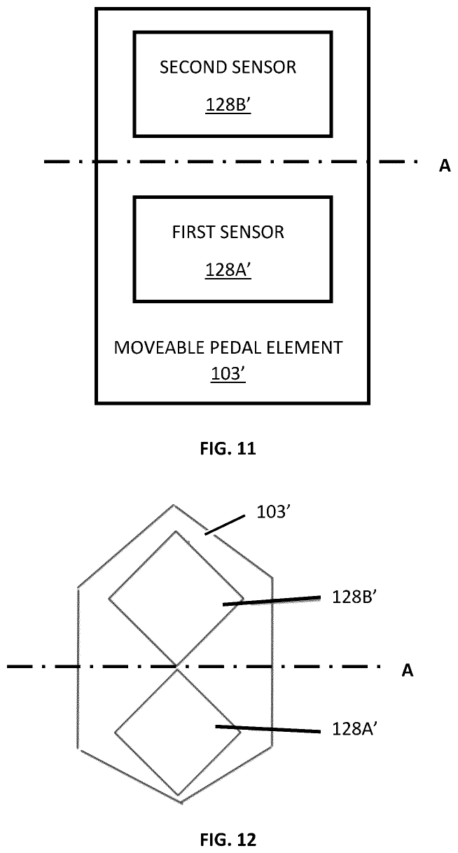

In one embodiment, as shown in FIG. 11, a first sensor 128A′ (e.g., a first FSR) can be located at a front side of the pivot axis A of the foot-operable movable pedal element 103′ (closer to the user), while a second sensor 128B′ (e.g., a second FSR) can be located at a rear side of the pivot axis A (away from the user). That is, the first and second sensors 128A′ and 128B′ can be located at opposite sides of the pivot axis A, about which the movable pedal element 103′ can pivot based on user control (e.g., foot actuation by the user). Each sensor 128A′ and 128B′ can sense the presence of a user's appendage, such as the user's foot, on the movable pedal element 103′ adjacent to the corresponding sensor(s) 128A′ and/or 128B′. A user can position his or her foot on different portions of the movable pedal element 103′ depending on the desired operation mode of the pedal 100′, and the pedal 100′ (e.g., via the on-board microcontroller 112′) can user input from the first and second sensors 128A′ and/or 128B′ to determine the position of the user's appendage and command an operational mode of the pedal 100′, such as between a binary switching mode (e.g., “sustain” mode involve discrete trigger signals) or a continuous control mode (e.g., “modulation” or “expression” mode). A given sensor 128A′ or 128B′ can be considered “on” when that sensor 128A′ or 128B′ detects the presence of a user's appendage above that sensor 128A′ and/or 128B′, and conversely can be considered “off” when no user appendage is detected above. For instance, if the first sensor 128A′ is ON and the second sensor 128B′ is OFF, the pedal 100′ can work in sustain mode, and if the first sensor 128A′ is ON and the second sensor 128B′ is also ON the pedal 100′ can work in modulation mode. In this way, the combined operational ON/OFF (or activated/deactivated) states of the first and second sensors 128A′ and/or 128B′ can act as a gate for modulation messages.

FIG. 12 shows an alternate embodiment in which the first and second sensors 128A′ and/or 128B′ are each substantially rectangular FSRs arranged diagonally (e.g., at approximately 45° relative to the pivot axis, with adjacent corners of the first and second sensors 128A′ and/or 128B′ pointing at each other). The operation of the embodiment of FIG. 12 can otherwise be substantially similar or identical to that described with respect to the embodiment of FIG. 11. Moreover, other shapes and arrangements of the first and second sensors 128A′ and/or 128B′ are possible in further embodiments. For example, a cross-shaped sensor arrangement can be utilized in a further embodiment.

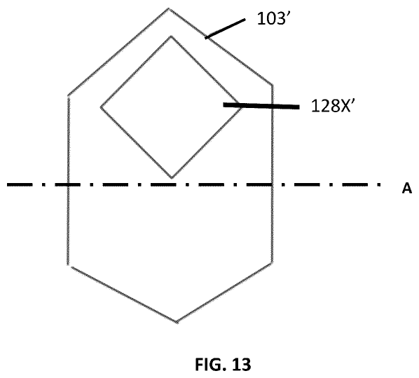

FIG. 13 shows yet another embodiment, which utilizes a single sensor 128X′ (e.g., a FSR) rather than two sensors as shown in the embodiments of FIGS. 11 and 12. More particularly, as shown in the embodiment of FIG. 13, the sensor 128X′ is located at a rear side of a pivot axis A of the foot-operable movable pedal element 103′ (away from the user). If the sensor 128X′ is ON (i.e., detecting the present of a user's appendage such as the user's foot adjacent to the sensor 128X′ on the movable pedal element 103′), the pedal 100′ can work in a continuous control mode (e.g., a modulation or “expression” mode), and if the sensor 128X′ is OFF the pedal 100′ can work in a binary switching mode (e.g., a sustain mode). In this way, the ON/OFF (or activated/deactivated) state of the sensor 128X′ can act as a gate for modulation messages. The embodiment of FIG. 13 allows the same or similar functionality as the embodiments of FIGS. 11 and 12, but utilizing only a single user appendage-detecting sensor rather than multiple sensors.

Various breakout cables can optionally be utilized with the pedal 100′. For example, a first breakout cable connectable to the pedal 100′ can be a USB-C to single ¼″ mono female phono connector engageable with the connector port 140D. The first breakout cable can allow the user to connect the pedal 100′ via a ¼″ mono phono cable to a keyboard or other musical instrument, such as to a sustain socket in such a musical instrument, allowing the pedal 100′ to be used like a regular sustain pedal. A second breakout cable can be a USB-C to dual ¼″ mono female phono connector engageable with the connector port 140D. The second breakout cable can allow the user to connect the pedal 100′ via a ¼″ mono phono cable to the sustain pedal socket on a keyboard or other musical instrument, allowing the pedal 100′ to be used like a regular sustain pedal, and the analog connector port (socket) 140A in the same way to the expression pedal socket of the musical instrument, for fully wired functionality. A third breakout cable engageable with the digital connector port 140D can be a USB-C to single 5-pin DIN plug for legacy MIDI connections. The single DIN plug of the third breakout cable can output MIDI messages for both sustain and modulation modes. It should be noted that any of the break-out cables described can be used as desired for particular applications, or can be omitted for fully wireless implementations. A kit containing multiple break-out cables can be provided in some embodiments.

Moreover, firmware versioning for the microcontroller 112′ and/or other components of the pedal 100′ can also control features. For instance, a basic version can provide for switch/sustain mode only, a mid-level version can provide all basic functions plus drum mode, and a top-level version can provide all basic a mid-level version functions plus an expression/modulation mode. In this way, the same hardware can be differently enabled utilizing firmware and/or software controls, which can be modified or locked/unlocked over time. For instance, a given device can have different features activated or deactivated over time through firmware and/or software versioning.

Those skilled in the art would appreciate that embodiments of the present disclosure provide first of a kind multifunctional foot operated MIDI-compatible pedal that allows hands of the user to be free to perform polyphonic music, making the musical performance a more organic one. The pedal 100 or 100′ also saves on workflow time and increase cogency of musical expression significantly. Therefore, there is no requirement for the user to either play musical part meant to be played by their other hand or draw automation of the MIDI parameters as a separate process after the polyphonic performance using both hands. Thereby, providing ease to the musician for an instinctive musical performance.

Those skilled in the art would appreciate that kick drum pedals are usually a part of a dedicated electronic drum kit or meant to be connected to an electronic drum module. The pedal 100 or 100′, disclosed herein, can offer the same functionality outside such a dedicated hardware based electronic drum kit, by assigning MIDI note ON/OFF message to any particular note, be it a kick or any other sound for the user to assign during a performance. The pedal 100 or 100′ could also be used to assign sustained bass notes or sound fix or any other sound that the user needs to trigger during a musical performance.

While specific embodiments of the invention have been described in detail, it will be appreciated by those skilled in the art that various modifications and alternatives to those details could be developed in light of the overall teachings of the disclosure. The presently preferred embodiments described herein are meant to be illustrative only and not limiting as to the scope of the invention which is to be given the full breadth of the appended claims and any and all equivalents thereof. For example, although the use of wireless or Bluetooth® wireless signals have been discussed, signals and communications described herein can instead be transmitted over wired connections in alternative embodiments.

While the foregoing describes various embodiments of the invention, other and further embodiments of the invention may be devised without departing from the basic scope thereof. The invention is not limited to the described embodiments, versions, implementations, or examples, which are included to enable a person having ordinary skill in the art to make and use the invention when combined with information and knowledge available to the person having ordinary skill in the art. For example, features described with respect to one embodiment can generally be utilized with features of any other disclosed embodiment. Moreover, while described with respect to usage with musical instruments, the disclosed pedal can have functionality for use in other control applications, such as for controlling video game console operations, as an alternative to hand-operated controllers or switches for differently-abled users who are less able to use handheld controllers, and the like.

1. A pedal comprising:
a base;
a movable pedal element connected to the base and movable relative to the base;
a spring arranged to bias the movable pedal element to a neutral position;
a microcontroller including at least one processor; and
a sensor unit operably connected to the microcontroller and configured to send data related to the movable pedal element to the microcontroller, wherein the sensor unit is an integrated accelerometer/gyroscope dual sensor micro electromechanical systems device carried by the movable pedal element,
wherein the microcontroller is programmed to generate an output signal during operation as a function of user force input to the movable pedal element, wherein the output signal is generated in at least two different modes including a switch mode and a continuous modulation mode, wherein in the switch mode the output signal is a discrete trigger, and wherein in the continuous modulation mode the output signal is continuously variable over a range.

2. The pedal of claim 1, wherein the sensor unit is configured to sense acceleration and angular velocity of the movable pedal element along three perpendicular axes.

3. The pedal of claim 1 and further comprising:
a pivot connection pivotally connecting the movable pedal element to the base, wherein the pivot connection has only a single degree of freedom of pivoting movement.

4. The pedal of claim 3, wherein the pivot connection is located at a middle portion of the movable pedal element, in between front and rear ends of the movable pedal element.

5. The pedal of claim 1 and further comprising:
a proximity sensor configured to detect proximity of the movable pedal element to a target, the proximity sensor operatively connected to the microcontroller, wherein the microcontroller is configured to utilize data from the proximity sensor to generate the output signal as a function of user input to the movable pedal element detected by the proximity sensor in the switch mode.

6. The pedal of claim 1 and further comprising:
a wireless transceiver operably connected to the microcontroller and capable of wirelessly sending and receiving signals.

7. The pedal of claim 1 and further comprising:
an analog connector port operably connected to the microcontroller capable of creating an electrical connection with an external cable, wherein wireless transceiver and the analog connector port are configured to operate concurrently such that one of the wireless transceiver and the analog connector port is operable to transmit the output signal and the other of the wireless transceiver and the analog connector port is operable to independently transmit an additional output signal.

8. The pedal of claim 1 and further comprising:
a connector port operably connected to the microcontroller capable of creating a connection with an external cable.

9. The pedal of claim 1, wherein the microcontroller is programmed to disable the continuous modulation mode as a function of feature version control instructions.

10. The pedal of claim 1 and further comprising:
a user appendage-detecting sensor carried by the movable pedal element and operatively connected to the microcontroller, wherein the microcontroller is programmed to automatically switch operating modes between the switch mode and the continuous modulation mode as a function of data from the user appendage-detecting sensor indicative of the presence or absence of a user appendage on the movable pedal element adjacent to the user appendage-detecting sensor.

11. The pedal of claim 10, wherein the user appendage-detecting sensor comprises a force sensing resistor.

12. The pedal of claim 10, wherein the user appendage-detecting sensor is located at a rear side of a pivot axis of the movable pedal element.

13. The pedal of claim 12 and further comprising:
an additional user appendage-detecting sensor carried by the movable pedal element and operatively connected to the microcontroller, wherein the additional user appendage-detecting sensor is located at a front side of the pivot axis.

14. The pedal of claim 1 and further comprising:
a button operatively connected to the microcontroller, wherein the microcontroller is programmed to switch operating modes between the switch mode and the continuous modulation mode as a function of manual actuation of the button.

15. The pedal of claim 1, wherein the output signal is in a musical instrument digital interface (MIDI) format.

16. A system comprising:
a pedal according to claim 1; and
a host computing system running digital audio workstation environment software that is operatively connected to the pedal.

17. The system of claim 16, wherein the output signal is converted to a musical instrument digital interface (MIDI) format by the host computing system.

18. A method of operating a pedal, the method comprising:
generating sensor data with a sensor unit as a function of actuation of a movable pedal element;
sending the sensor data to a microcontroller;
processing the sensor data with the microcontroller to determine a user actuation command;
determining an operating mode of the pedal with the microcontroller, wherein the pedal is operable in at least a switch mode and a continuous modulation mode; and
generating an output signal as a function of the user actuation command, wherein the output signal is generated as a function of the operating mode then in effect, wherein the output signal is a discrete trigger in the switch mode, and wherein the output signal is continuously variable over a range in the continuous modulation mode.

19. The method of claim 18 and further comprising:
generating a detection signal indicative of the presence of a user appendage on a rear portion of the movable pedal element; and
using the microcontroller to automatically switch operating modes of the pedal between the switch mode and the continuous modulation mode as a function of the detection signal.

20. The method of claim 18 and further comprising:
using the microcontroller to switch operating modes of the pedal between the switch mode and the continuous modulation mode as a function of manual actuation of a button.

21. The method of claim 18, wherein the movable pedal element is actuated by a user's foot.

22. The method of claim 18 and further comprising:
establishing a wireless connection between the microcontroller of the pedal and a first musical instrument; and
wirelessly transmitting the output signal.

23. The method of claim 22 and further comprising:
providing a wired connection between the microcontroller and a second musical instrument via a connector port on the pedal; and
transmitting signals along both the wireless connection and the wired connection concurrently and independently in the switch mode.

24. A method of operating a pedal, the method comprising:
generating sensor data indicative of the presence of a user appendage on a rear portion of a movable pedal element, wherein the movable pedal element is actuatable by the user appendage;
sending the sensor data to a microcontroller;
processing the sensor data with the microcontroller to automatically determine an operating mode of the pedal, wherein the pedal is operable in at least two different operating modes including a switch mode and a continuous modulation mode; and
generating an output signal, wherein the output signal is generated as a function of the operating mode automatically determined by the microcontroller.

25. A pedal comprising:
a base;
a movable pedal element connected to the base and movable relative to the base;
a microcontroller including at least one processor;
a sensor unit operably connected to the microcontroller and the movable pedal element and further configured to send data to the microcontroller indicative of user actuation of the movable pedal element; and
a wireless transceiver operably connected to the microcontroller and capable of wirelessly sending and receiving signals,
wherein the microcontroller is programmed to generate an output signal during operation as a function of user input to the movable pedal element in at least a switch mode in which the output signal signals activation when the movable pedal element is depressed to a trigger point.
